(19) United States
(12) Patent Application Publication
(10) Pub. No.: US 2007/0292005 A1
(43) Pub. Date: Dec. 20, 2007

(54) METHOD AND APPARATUS FOR ADAPTIVE HIERARCHICAL PROCESSING OF PRINT IMAGES

(75) Inventors: PETER Z. LO, LAKE FOREST, CA (US); YING LUO, IRVINE, CA (US)

Correspondence Address: MOTOROLA, INC., 1303 EAST ALGONQUIN ROAD, IL01/3RD, SCHAUMBURG, IL, 60196, US

(73) Assignee: MOTOROLA, INC.

(21) Appl. No.: 11/456,622

(22) Filed: Jul. 11, 2006

Related U.S. Application Data
(60) Provisional application No. 60/804,825, filed on Jun. 14, 2006.

(51) Int. Cl. G06K 9/00

(52) U.S. Cl. 382/124

(57) ABSTRACT

Print image processing includes generating a first direction image and a multi-resolution hierarchy tree (MRT) having a plurality of direction measures, and adjusting at least one direction measure based on whether it is associated with a singularity area or a non-singularity area of the MRT, to output a final first direction image used for further print image processing. The MRT direction images include the first direction image having a highest resolution and at least one other direction image having a lower resolution. Each direction measure is determined from a direction measure, in a higher resolution direction image, which is selected based on image quality and distance from the boundary between print areas and non-print areas. Upon determining the final first direction image, a consistency measure can be computed and compared to a consistency metric and the method iteratively performed until the consistency measure satisfies the consistency metric.

This application claims the benefit of prior filed co-pending U.S. Provisional Patent Application No. 60/804,825 filed Jun. 14, 2006, and entitled Method and Apparatus for Adaptive Hierarchical Processing of Print Images, by Lo, et al.

### FIELD OF THE INVENTION

The present invention relates generally to print image processing and more particularly to feature extraction methods in fingerprint image pre-processing in automatic fingerprint identification systems.

### BACKGROUND OF THE INVENTION

Identification pattern systems, such as ten prints or fingerprint identification systems, play a critical role in modern society in both criminal and civil applications. For example, criminal identification in public safety sectors is an integral part of any present day investigation. Similarly in civil applications such as credit card or personal identity fraud, print identification has become an essential part of the security process.

An automatic fingerprint identification operation normally consists of two stages. The first is the registration stage and the second is the identification stage. In the registration stage, the register's prints and personal information are enrolled, and features, such as minutiae, are extracted. The personal information and the extracted features are then used to form a file record that is saved into a database for subsequent print identification. Present day automatic fingerprint identification systems may contain several hundred thousand to a few million of such file records. In the identification stage, print features from an individual, or latent print, and personal information are extracted to form what is typically referred to as a search record. The search record is then compared with the enrolled file records in the database of the fingerprint matching system. In a typical search scenario, a search record may be compared against millions of file records that are stored in the database and a list of matched scores is generated after the matching process. Candidate records are sorted according to matched scores. A matched score is a measurement of the similarity of the print features of the identified search and file records. The higher the score, the more similar the file and search records are determined to be. Thus, a top candidate is the one that has the closest match.

However it is well known from verification tests that the top candidate may not always be the correctly matched record because the obtained prints may vary widely in quality. Smudges, individual differences in technique of the personnel who obtain the prints, equipment quality, and environmental factors may all affect print quality. To ensure accuracy in determining the correctly matched candidate, the search record and the top “n” file records from the sorted list are provided to an examiner for manual review and inspection. Once a true match is found, the identification information is provided to a user and the search print is typically discarded from the identification system. If a true match is not found, a new record is created and the personal information and print features of the search record are saved as a new file record into the database.

Many solutions have been proposed to improve the accuracy of automatic fingerprint identification systems (AFIS) and reduce the workload of manual examiners. Among these technologies, highly reliable feature extraction algorithms are critical to the accuracy of the AFIS. Feature extraction algorithms generally include the procedures of image pre-processing, direction field estimation, singularity point (e.g., core and delta) detection, image enhancement, image binarization, image thinning and minutiae detection. Both singularity point detection and image enhancement depend on reliable direction field estimation. The direction field based singularity features, together with the minutiae, have traditionally been the two most widely used features, which are output from feature extraction. However, recently, certain other features including, but not limited to, additional features associated with the direction field (e.g., pseudo-ridges) have also been used to enhance the accuracy of AFIS. Thus, direction field estimation plays an important role in feature extraction.

There are many known methodologies to estimate the direction field. In each of these methodologies, the direction field is derived from either gray level gradients of print images (also known in the art as gray-scale images) or the slim sum in local areas and comprises a plurality of direction field values or measures corresponding to pixel locations in the direction field. Furthermore, these methodologies generally require the step of smoothing (or adjusting) the direction field by averaging all direction field values in predetermined block sizes of pixel locations to avoid noise (manifested by inconsistencies in computed direction values at pixel locations in certain areas of the direction field) prior to using the direction field for singularity point detection, image enhancement, etc.

One problem that can be associated with direction field smoothing is that strong averaging may destroy a true singularity point in the direction field and make both the image enhancement and the singularity point detection unreliable, while weak averaging cannot handle strong noises (like scars) which are frequently detected as singularity points. Thus to address these problems, some known methodologies detect singularity points before the direction field smoothing to avoid elimination of singularity points. However, this doesn't really address the problem because upon closer examination of the singularity point detection process, in fact two interrelated or interleaved problems emerge: the detection of singularity points is sensitive to noise so smoothing the direction field is typically necessary to reliably detect the singularity points; on the other hand, accurate singularity point detection is needed to distinguish the noisy areas in order to improve the direction field. Today these two interleaved problems are handled separately in pragmatic ways in most applications. Namely, when the direction field smoothing is in focus, singularity points are detected first, so as not to destroy the singularity point. Whereas, when the singularity point detection is in focus, the direction field smoothing is performed first to avoid false detection of singularity points due to noise.

However, it would be desirable to have a comprehensive methodology that improves both the direction field estimation and singularity point detection procedures instead of one that improves one procedure at the expense of the other. Such enhancement to both direction field estimation and singularity point detection can be used, for example, to further improve the accuracy of an AFIS.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram of an AFIS implementing embodiments of the present invention.

FIG. 2 illustrates core and delta singularity points on a print image, the detection of which can be enhanced using embodiments of the present invention.

FIG. 3 illustrates a direction field for a print image, the generation of which can be enhanced using embodiments of the present invention.

FIG. 4 illustrates a flow diagram of a method in accordance with an embodiment of the present invention.

FIG. 5 illustrates a more detailed flow diagram of a method in accordance with an embodiment of the present invention.

FIG. 6 illustrates an exemplary technique used to construct a multi-resolution hierarchical tree in accordance with an embodiment of the present invention.

FIG. 7 illustrates another exemplary technique used to construct a multi-resolution hierarchical tree in accordance with an embodiment of the present invention.

FIG. 8 illustrates another exemplary technique used to construct a multi-resolution hierarchical tree in accordance with an embodiment of the present invention.

### DETAILED DESCRIPTION OF EMBODIMENTS OF THE INVENTION

Before describing in detail embodiments that are in accordance with the present invention, it should be observed that the embodiments reside primarily in combinations of method steps and apparatus components related to a method and apparatus for processing a print image. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the invention described herein may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for processing a print image described herein. The non-processor circuits may include, but are not limited to, user input devices. As such, these functions may be interpreted as steps of a method to perform the processing of a print image described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment of the present invention can be implemented as a computer-readable storage element having computer readable code stored thereon for programming a computer (e.g., comprising a processing device) to perform a method as described and claimed herein. Examples of such computer-readable storage elements include, but are not limited to, a hard disk, a CD-ROM, an optical storage device and a magnetic storage device. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, an iterative method to reliably detect singularity points, such as cores and deltas, and to generate a better direction field of a print image, such as a fingerprint image, is disclosed. In accordance with the teachings herein, the detected singularity points aid the smoothing of the direction field, and the smoothed direction field is used to more effectively detect the singularity points. In particular, the method discloses a hierarchical direction field smoothing based on consistency between a higher level (and lower resolution) block-based direction field and a lower level (and higher resolution) block-based direction field with the guidance of singularity point location and a direction measure clustering analysis. In comparison to traditional direction field smoothing, the method can smooth direction field iteratively without destroying the singularity points, while bad quality areas gradually obtain reasonable predicted direction based on the hierarchical consistency analysis. Those skilled in the art will realize that the above recognized advantages and other advantages described herein are merely exemplary and are not meant to be a complete rendering of all of the advantages of the various embodiments of the present invention.

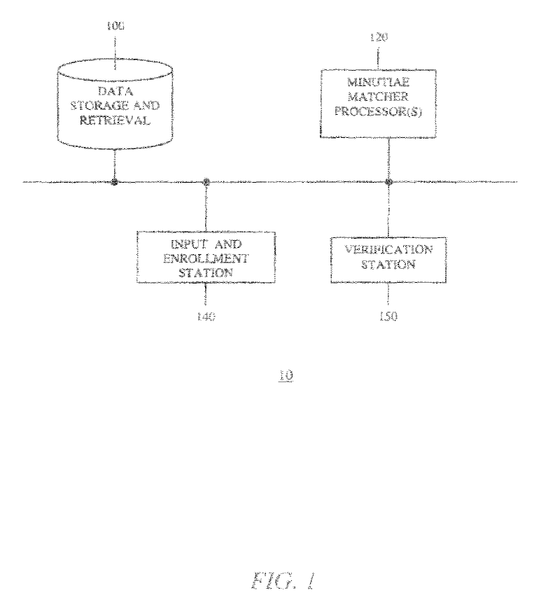

Referring now to the drawings, and in particular FIG. 1, a block diagram of an exemplary fingerprint matching system implementing embodiments of the present invention is shown and indicated generally at 100. Although fingerprints and fingerprint matching is specifically referred to herein, those of ordinary skill in the art will recognize and appreciate that the specifics of this illustrative example are not specifics of the invention itself and that the teachings set forth herein are applicable in a variety of alternative settings. For example, since the teachings described do not depend on the type of print being analyzed, they can be applied to any type of print (or print image), such as toe and palm prints (images). As such, other alternative implementations of using different types of prints are contemplated and are within the scope of the various teachings described herein.

System 100 is generally known in the art as an Automatic Fingerprint Identification System or (AFIS) as it is configured to automatically (typically using a combination of hardware and software) compare a given search print record (for example a record that includes an unidentified latent print or a known ten-print) to a database of file print records (e.g., that contain ten-print records of known persons) and identifies one or more candidate file print records that match the search print record. The ideal goal of the matching process is to identify, with a predetermined amount of certainty and without a manual visual comparison, the search print as having come from a person who has prints stored in the database. At a minimum, AFIS system designers and manufactures desire to significantly limit the time spent in a manual comparison of the search print to candidate file prints (also referred to herein as respondent file prints).

Before describing system 100 in detail, it will be useful to define terms that are used herein.

A print is a pattern of ridges and valleys on the surface of a finger (fingerprint), toe (toe print) or palm (palm print), for example.

A print image is a visual representation of a print that is stored in electronic form.

A gray scale image is a data matrix that uses values, such as pixel values at corresponding pixel locations in the matrix, to represent intensities of gray within some range.

A minutiae point or minutiae is a small detail in the print pattern and refers to the various ways that ridges can be discontinuous. Examples of minutiae are a ridge termination or ridge ending where a ridge suddenly comes to an end and a ridge bifurcation where a ridge divides into two ridges.

A similarity measure is any measure (also referred to herein interchangeable with the term score) that identifies or indicates similarity of a file print to a search print based on one or more given parameters.

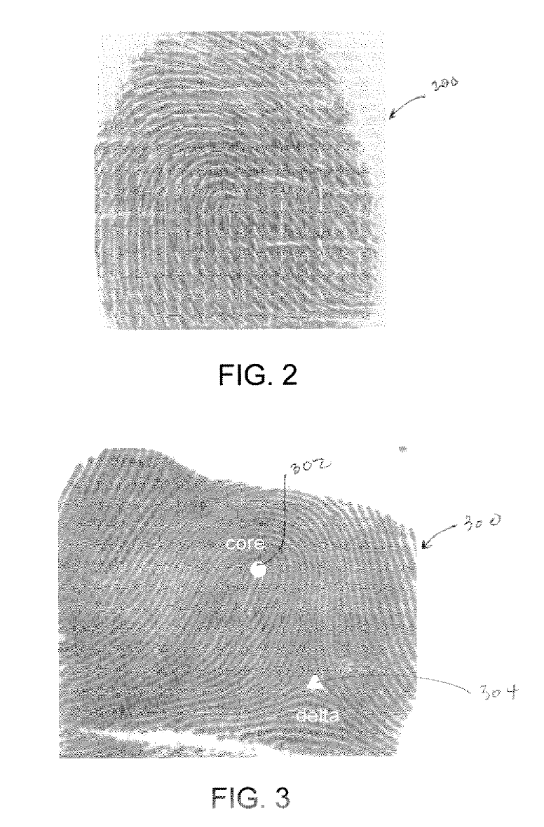

A direction field (also known in the art and referred to herein as a direction image) is an image indicating the direction the friction ridges point to at a specific image location. The direction field can be pixel-based, thereby, having the same dimensionality as the original fingerprint image. It can also be block-based through majority voting or averaging in local blocks of pixel-based direction field to save computation and/or improve resistance to noise. FIG. 2 illustrates a direction image 200 of a fingerprint.

A direction field measure or value is the direction assigned to a point (e.g., a pixel location) or block on the direction field image and can be represented, for example, as a slit sum direction, an angle or a unit vector.

A singularity point is a core or a delta.

In a fingerprint pattern, a core is the approximate center of the fingerprint pattern on the most inner recurve where the direction field curvature reaches the maximum. FIG. 3 illustrates a core singularity point 302 on a fingerprint image 300.

According to ANSI-INCITS-378-2004 standard, a delta is the point on a ridge at or nearest to the point of divergence of two type lines, and located at or directly in front of the point of divergence. FIG. 3 further illustrates a delta singularity point 304 on the fingerprint image 300.

Turning again to FIG. 1, an AFIS that may be used to implement the various embodiments of the present invention described herein is shown and indicated generally at 10. System 10 includes an input and enrollment station 140, a data storage and retrieval device 100, one or more matcher processors 120, e.g., minutiae matcher processors, and a verification station 150.

The input and enrollment station 140 may be configured for implementing the various embodiments of the present invention in any one or more of the processing devices described above. Moreover, input and enrollment station 140 is further used to capture fingerprint images to extract the relevant features (minutiae, cores, deltas, the direction image, etc.) of those image(s) to generate file records and a search record for later comparison to the file records. Thus, input and enrollment station 140 may be coupled to a suitable sensor for capturing the fingerprint images or to a scanning device for capturing a latent fingerprint.

Data storage and retrieval device 100 may be implemented using any suitable storage device such as a database, RAM (random access memory), ROM (read-only memory), etc., for facilitating the AFIS functionality. Data storage and retrieval device 100, for example, stores and retrieves the file records, including the extracted features, and may also store and retrieve other data useful to carry out embodiments of the present invention. Matcher processors 120 use the extracted features of the fingerprint images to determine similarity or may be configured to make comparisons at the image level. One such matcher processor may be a conventional minutiae matcher for comparing the extracted minutiae of two fingerprint images. Finally, verification station 150 is used, for example by a manual examiner, to verify matching results.

It is appreciated by those of ordinary skill in the art that although input and enrollment station 140 and verification station 150 are shown as separate functional boxes in system 10, these two stations may be implemented in a product as separate physical stations (in accordance with what is illustrated in FIG. 1) or combined into one physical station in an alternative embodiment. Moreover, where system 10 is used to compare one search record for a given person to an extremely large database of file records for different persons, system 10 may optionally include a distributed matcher controller (not shown), which may include a processor configured to more efficiently coordinate the more complicated or time consuming matching processes.

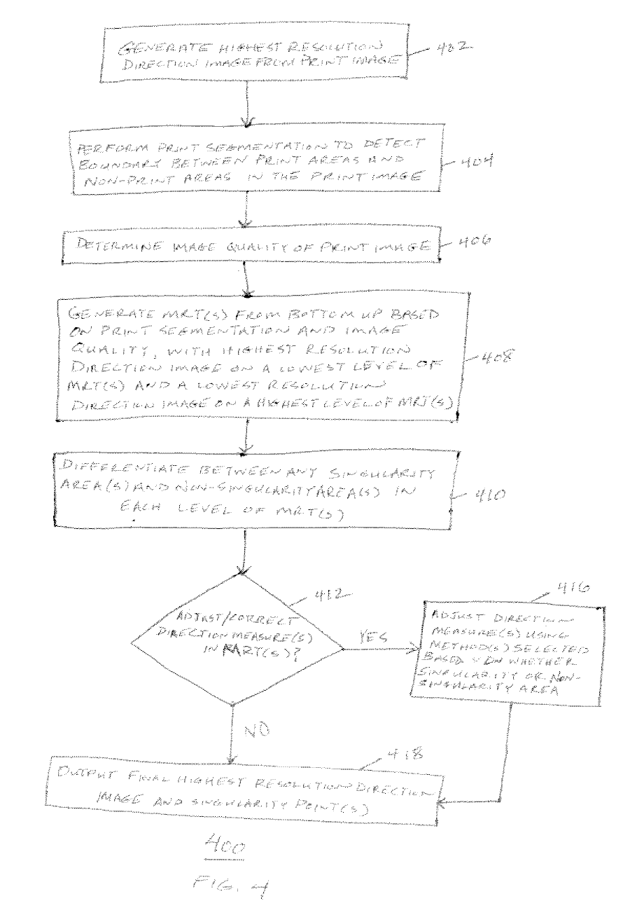

Turning now to FIG. 4, a high-level flow diagram illustrating an exemplary method for processing a print (e.g., fingerprint, toe print, palm print) image in accordance with an embodiment of the present invention is shown and generally indicated at 400. At a step 402, a highest resolution direction image is generating corresponding to the print image and comprising a first plurality of direction measures. This highest resolution image can be the highest possible pixel-based resolution direction image having the same dimensionality as the print image or the highest resolution block-based direction image that will be used to implement embodiments of the present invention. Any suitable process for generating a direction image can be used in this step including any of the traditional methods such as, for instance, gradient or slit sum methods that are well known in the art and, therefore, will not be explained in detail here for the sake of brevity.

At a step 404, print segmentation is performed to detecting a boundary between print areas and non-print areas (also referred to herein as background) in the print image. As with the step of generating the direction image, any suitable method for print segmentation is included within the scope of the teachings herein. At step 406, image quality, in one embodiment at every print area point (e.g., pixel location) in the print image, is determined. Once again any suitable method used for this step is included within the scope of the teachings herein. Steps 402-406 are generally known in the art and also referred to herein as steps included in the “pre-processing” of the print image.

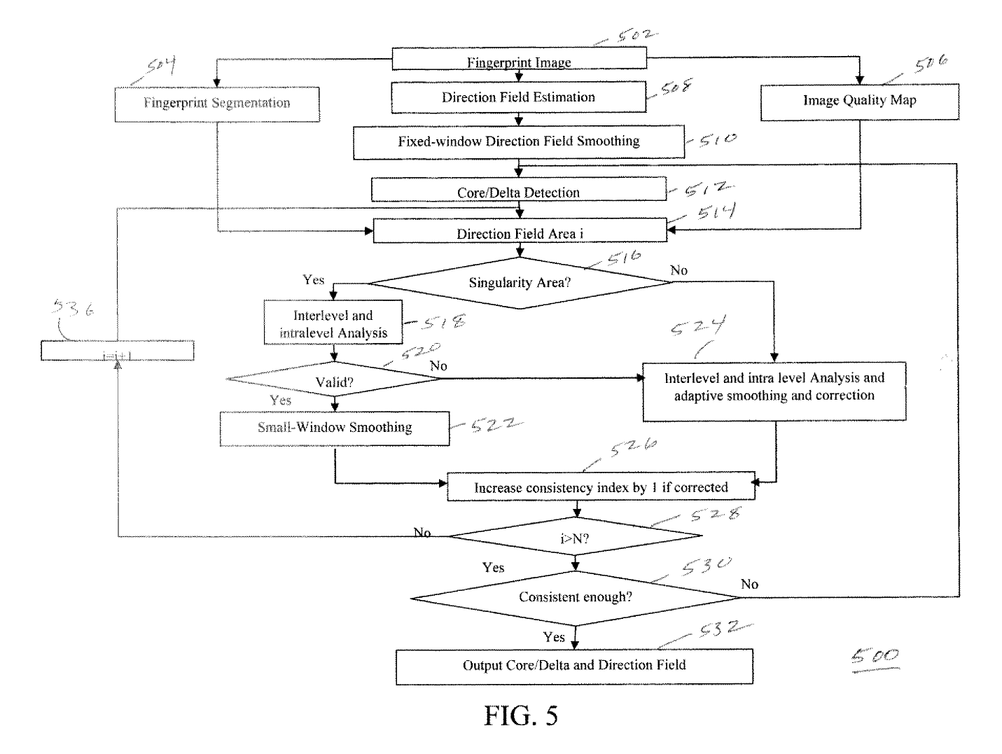

At a step 408, at least one multi-resolution hierarchical tree (“MRT”) is generated in accordance with the teachings herein. The creation of the MRT will now be described in general, and then specific exemplary implementations will be described in detail below by reference to FIGS. 5-8. In general, the MRT is constructed in a “pyramid-type” manner having a plurality of direction images with different resolutions, with a highest resolution direction image (such as the one generated at step 402) at the bottom level of the MRT and at least one other higher level direction image having a lower resolution than the direction image at the bottom level and further comprising a plurality of direction values. The top level of the MRT has the lowest resolution, and direction images from the top level down to the bottom level increase in resolution, with resolution being associated with the number of pixel locations represented by a given point or cell in the direction image.

The MRT is constructed from the “bottom up” meaning that each point in a higher level direction image is assigned a direction measure that is determined based on the direction measures previously assigned to a set of points selected from a lower level, higher resolution, direction image in the MRT. A differentiating feature of MRT construction in accordance with the teachings herein is that the points selected from a lower level direction image to generate directions measures for points in a higher level direction image are selected based on image quality associated with the selected points (as determined using the information determined from step 406) and/or the relative distance of the selected points from the boundary between a print area and a non-print area (as determined using the information generated from the print segmentation process performed in step 404). Exemplary implementations of this point selection process used in constructing an MRT in accordance with embodiments of the present invention are detailed below.

At a step 410, in each level of the MRT any singularity area(s) in the direction image are differentiated from non-singularity areas in the direction image. A singularity area comprises at least one true or “valid” singularity point and perhaps other non-singularity points that are within a predetermined distance from the true singularity point. Another differentiating feature of the embodiments disclosed herein is that this information is used in direction image smoothing as detailed below.

Direction image “smoothing” can now be performed in accordance with embodiments of the present invention. Smoothing is the process of determining whether and what direction measures to adjust in the MRT to generate a final direction image that is output for use in further processing of the print image. A step 412 in general represents the decision logic for this smoothing process. Although not explicitly shown in FIG. 4, the decision logic applies to the entire MRT and desirably all points in every direction image of the MRT is subject to this decision logic associated with the smoothing process.

Where a decision is made to adjust or “correct” one or more of the direction measures in any level of the MRT, the correction is performed at step 416. In accordance with embodiments of the invention, correction of the direction measure for a point in a direction image is performed using an adjustment/correction methodology that is selected from multiple possible correction methodologies. Multiple such correction methodologies are utilized in the disclosed embodiments so that a different methodology can be used depending on whether the direction measure being corrected is assigned to a point in a singularity area or a non-singularity area. This enables controlled smoothing so that points in a singularity area can be smoothed to a lesser degree than points in non-singularity areas to minimize the possibility of destroying the singularity point through excessive smoothing. This controlled smoothing also concurrently enables bad quality and noisy areas to be subject to greater levels of smoothing to minimize the noise to an acceptable level.

Moreover, the decision logic can further provide for detecting consistency or inconsistency between direction measures in successive levels, for example in adjacent levels, of the MRT for use in correcting the direction measures in the lower level. This enables a beneficial “top down” approach to smoothing that will be explained in more detail below by reference to the exemplary implementations of the embodiments.

Upon completion of the smoothing process, both a final direction image with any corrected directions measures as well as all detected and validated singularity points are output for further image processing. The final direction image is likely, although not necessarily, the direction image generated in step 402, with any corrected direction values. A further optional but very beneficial feature of embodiments of the invention (which is not shown in FIG. 4 but is shown in FIG. 5, e.g., via decision blocks 528 and 530), is the use of a direction image consistency loop. In accordance with the consistency loop, a consistency measure corresponding to the entire smoothed direction image (that could potentially be output from the overall process as the final direction image) is calculated and compared to a direction image consistency metric or threshold. Where the consistency metric is not satisfied, steps 410, 412 and 416 are iteratively performed until the consistency measure is satisfied. It should be noted that the MRT used during a current iteration is the corrected MRT generated during the previous iteration so that the overall process performs continuously smoothing of direction images in the MRT until an acceptable final direction image (and consequently improved singularity point detection) is generated.

In FIG. 5, a flow diagram of a more detailed method 500 for implementing the steps of method 400 is shown. This method includes the beneficial implementation details that were briefly mentioned above. Moreover, method 500 is described in terms of a fingerprint identification process (such as one implemented in the AFIS shown in FIG. 1) for ease of illustration. However, it is appreciated that the method may be similarly implemented in biometric image enrollment for other types of prints such as, for instance, palm prints or toe prints without loss of generality. Thus, these other types of prints and images are contemplated within the meaning of the terms “print” and “fingerprint” as used in the various teachings described herein.

An overview of method 500 will first be described, followed by a detailed explanation of an exemplary implementation of method 500 in an AFIS. A fingerprint image (502) is received into the AFIS via any suitable interface. For example, the fingerprint image 502 can be captured from someone's finger using a sensor coupled to the AFIS or the fingerprint image could have been scanned into the AFIS from a ten-print card, for example, used by a law enforcement agency. The fingerprint image is stored electronically in data storage and retrieval unit 100. The remaining steps are implemented using a processing device.

Pre-processing is first performed on the fingerprint image, which includes but is not limited to, fingerprint segmentation (step 504), direction field estimation (step 508) and generation of an image quality map (step 506). It should be realized by those of ordinary skill in the art that steps 508, 504 and 506 of FIG. 5 directly correspond, respectively, to steps 402, 404 and 406 of FIG. 4 and, accordingly, are within the scope of the teachings herein regarding fingerprint processing.

After pre-processing, an initial moderate filter-based smoothing (step 510) is performed on the estimated direction field using a fixed-sized window for every pixel to generate a highest resolution pixel-level direction field. Any singularity areas (comprising at least one detected core or delta) are differentiated (step 512) from non-singularity areas in this initially smoothed direction field. In the remaining steps 516, 518, 520, 522, 524, 526, 528, 530 and 536, adaptive, hierarchical smoothing on at least one MRT generated for the fingerprint image is performed in accordance with the teachings herein, with the core/delta areas, fingerprint border and image quality in consideration.

It should be noted that the steps of method 500 do not explicitly illustrate where in the method the MRT is generated because MRT creation can be performed during different times in the process. For example, the one or more MRT can always be generated during a certain predetermined point in the process, such as before core/delta area detection so that core/delta detection is performed at this stage for all of the direction images in the MRT. Alternatively, the one or more MRT can be constructed on the fly as the overall method requires. Either implementation is included within the scope of the teachings herein.

Steps 516-528 are performed for every direction image level in the MRT and for each direction field area “i” (also referred to herein as a point or a cell or a block) in each direction image. This iterative approach is indicated by the inner loop comprising steps 514, 528, 536, which advances “i” by one value until all of the direction field areas in each level of the MRT have been processed. Upon determining at step 516 that direction field area/point “i” is in a core/delta area (e.g., based on detection at step 512), an interlevel and intralevel analysis of the MRT is performed (step 518) and validity of the detected core/delta is determined (step 520). The point is determined to be in a valid core/delta area if it is a valid core/delta point or is within a predetermined distance from a valid core/delta point.

During the MRT bottom-up building process of each level, core and delta points are detected. Some of the false core/delta points are detected due to noise in a bad area. Since a higher level MRT contains a smoother direction image, the false core/delta points detected in the lower level may be eliminated in the higher level image. Before top-down “smoothing” is started, the consistent detectability of these core/delta points between MRT levels is checked to eliminate the detected lower level points if they do not appear in the higher level detection. These consistent core/delta points are temporarily considered as valid points to guide “smoothing” process.

If validity is determined, a small-sized window filtering is performed (step 522) for this point. If invalidity is determined (e.g., the point is or is associated with a core/delta point determined to be invalid) or if the point was initially determined at step 516 to be in a non-singularity area, another intralevel and interlevel direction adaptive smoothing and correction based on multi-resolution analysis (MRT) and neighboring point analysis is performed (step 524). Throughout the smoothing process, the consistency of the direction field image is computed (step 526); in this case by increasing a consistency index by one any time the direction measure associated with a direction area is corrected. A decision logic checks (step 530) if the direction field is consistent enough by comparing the consistency index to a consistency metric. If it is not, a new round of core/delta detection and direction field smoothing is performed based on the newly smoothed direction field/MRT. This iterative procedure is performed until the direction field smoothing yields a satisfying result judged by the consistency metric. A core/delta detection process is applied again as described in the previous section to obtain more reliable core/delta points on the final MRT. A final smoothed direction field and validly detected core/delta points are output (step 532) as the final results.

An explanation of exemplary implementations of method 500 is detailed as follows. It should be kept in mind that many different implementations can be envisioned based on method 400 and/or 500. However, only certain ones are described to aid in understanding the teachings disclosed herein. Thus, the described implementations are in no way intended to narrow the scope of embodiments of the invention. As stated above, during the pre-processing steps the fingerprint image is segmented (step 504) to separate the fingerprint area and background. The image quality at every fingerprint area point is calculated (step 506), and direction field is estimated (508). For example, direction field can be estimated from gray level gradients using a gray-scale image of the fingerprint or from the slit sum in local areas. Except for non-fingerprint areas, strong under-ink areas and strong over-ink areas, every point is assigned a direction from 0° to 180°. Note that non-fingerprint areas also include the background area found through segmentation. The non-fingerprint area and strong under-ink area points are assigned a special “non-fingerprint” value NF and strong over-ink area points are assigned a “no-direction” value ND.

A benefit of the initial smoothing at step 510 is to decrease the likelihood of erroneously detecting noise as a core/delta. One simple and computationally efficient approach that can be used is a prior-art fixed-window smoothing filtering approach involving averaging the direction measures of neighboring points inside a fixed-size window around every point. However, care is chosen in selecting an appropriate window size so as not to encounter the shortcomings mentioned above that are associated with the prior art smoothing methodologies. The goal is to filter out some noise without destroying true singularity points, otherwise the process can lead to an altered ridge connection in the enhancement stage and corresponding possible errors in minutiae point detection.

The cores and deltas are detected at every level (e.g., step 512); in one embodiment using the well-known Poincaré index. However, other rule-based methods can be used and are within the scope of the teachings herein. We define the least distinguishable data unit in each level as a “pixel”. To decrease the probability of detecting noise as a core or delta point, the pixel-based smoothed direction image is first divided into a number of blocks having predetermined dimensions, and the singularity detection process is performed on each block. The representative direction of each block is calculated through majority voting (discrete direction) or averaging (continuous direction) of all the pixel point directions in the block. After a core or a delta is found in a specific block, the block is divided into smaller sub-blocks and the core or delta is detected again among these sub-blocks. When the sub-block size is chosen to be less than four pixels, one round of this operation is generally enough to accurately find the location of the core and delta since as level-one features, location error of the cores and deltas are not expected at the pixel level.

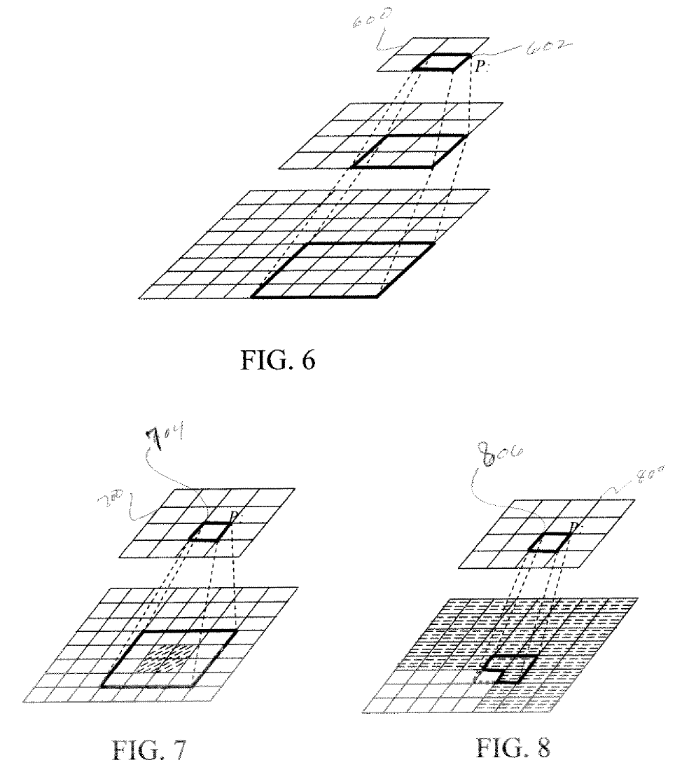

Described next are exemplary embodiments of the construction of a multi-resolution tree (MRT) and its use in the direction image smoothing process. As mentioned earlier, the MRT is built from the bottom up using image quality and print segmentation information as illustrated by references to FIGS. 6-8, for example. An MRT can be constructed against a direction image region or against the whole highest resolution image being used. Thus, an implementation is described, wherein the inventive smoothing methodology (also referred to herein as adaptive multi-resolution smoothing or “ARMS”) is performed using several MRTs constructed against different regions of the highest resolution direction image. In an alternative embodiment, ARMS is performed using a single MRT based on the entire highest resolution direction image.

The MRT has multiple levels of direction images each having a different resolution. The highest resolution direction image (e.g., estimated at step 508) is on the lowest level of the tree. The higher the level, the lower the resolution. Moreover, the direction measures comprising the high level direction images are calculated from the bottom up based on the direction measures comprising the lower-level direction images. In addition, as mentioned above, for a given point in a higher level direction image the points in the lower level used to determine its assigned direction measure are selected based on a quality measure associated with these points and/or based on distance of each of these points from a border between a print area and a non-print area.

For example, consider a point P with coordinates as (x,y) in a high-level as shown in FIG. 6 (point 602 in level 600), FIG. 7 (point 704 in level 700) and FIG. 8 (point 806 in level 800). The direction value of this point can be derived, in default, based on the four point set Pₛ={(2x,2y), (2x+1, 2y+1), (2x,2y+1), (2x+1, 2y+1)} in the next lower level unless other conditions add to or subtract from this initial point set based on the quality measure associated with each of these points and/or based on distance of each of these points from a border between a print area and a non-print area. It should be realized by those of ordinary skill in the art that alternative numbers of default point sets can be used in the calculations without a loss of generality. Further consider the following three exemplary cases that control how the direction values in an MRT are determined.

In a first case, illustrated by reference to FIG. 6, if the points in Pₛ are all inside the fingerprint area and their quality is greater than a threshold, say Qₜ, the direction of point P is calculated directly from Pₛ with majority voting or averaging. Qₜ can be set to 80 when 100 is considered as highest quality and 0 is considered as lowest quality, in one embodiment. The number can be adjusted according to different application requirements.

In a second case, illustrated by reference to FIG. 7, if the points in Pₛ are all inside the fingerprint area but one or more of these points has a quality value that is lower than Qₜ, each “low-quality” point is replaced by its eight neighbor points that are in the fingerprint area but not in Pₛ. The new points are unioned with Ps. Moreover, if there are low-quality points in the new points of Pₛ, the procedure is repeated again to replace each new low-quality point by its eight-neighbor points that are in fingerprint areas but not in Pₛ. As long as there are still low-quality points in the Pₛ, this procedure is repeated until a certain number j is reached or the new points are all out of fingerprint area, where Rⱼ is the rounds of extension allowed at the jth level. This parameter given by:

Rⱼ=2^{(O-1-j)}, j=1 (O-1)

where O is the number of levels in the MRT, and j starts from 1. The specific case shown in FIG. 7 is where all the four points (shaded area) are of low quality and the Ps is extended by one round. When there are still low-quality points in Pₛ at the termination of the above procedure, if the number of low-quality points is less than half of the number of Pₛ, the value of P is calculated from the rest of the points. Otherwise a value of ND is given to P.

In a third case, illustrated by reference to FIG. 8, one or more of the points in Pₛ is outside of the fingerprint area. When the number of points outside of the fingerprint area is greater than two, the value of point P is NF. Otherwise, calculation in the first or second case is still followed with the points outside of the fingerprint area being excluded from the computations. The specific illustration in FIG. 8 shows three of the four points in a fingerprint area (shaded area). These three points are used in the first or second case calculation.

Thus, the construction of the MRT is very flexible with the image quality and object border in consideration. As shown, its construction is not confined by the 2×2 window, nor is it even confined by a square window constraint. This manner of MRT construction minimizes or eliminates noise signal propagation between different levels of the tree.

Described next are two different embodiments of ARMS based on the MRT. In this first embodiment, an MRT is calculated for each of multiple regions of the smoothed direction image output from step 510. Returning first to step 516, for each detected singular point S in the direction field, the interlevel and intralevel analysis (step 518) is performed and validity is checked (step 520) using the following steps:
a. An MRT is constructed on a block with S as center. The block size is W (e.g., 8×8), and is determined according to different application requirements. Singularity detection again is performed on each level except for the lowest level (already done) and the levels with number of pixels less than eight (cannot detect singularity point due to too little number of points).
b. If singularity points are not found on every level, S is marked as an invalid singularity point of CASE 1 needing correction (detailed below), based on being located in a non-singularity area.
c. If singularity points are found on every level, a pseudo-ridge tracing, as is well-known in the art, is performed around S. If S is a core, choose the point above S and trace pseudo-ridge on both sides of this point. A pseudo-ridge is around a core if and only if its maximum curvature is larger than a predetermined threshold, the maximum curvature point is within a predetermined distance to the core point, and tails of the pseudo-ridge are parallel to the direction of the core. If S is a delta, find three neighbor points around S that are closest to the three directions of delta, and trace three pseudo-ridges starting from these points. Trace the three pseudo-ridges with a certain distance, if the direction of all three ridges is still within a threshold of the delta directions, the delta is declared as valid. If the pseudo-ridge conditions are satisfied, S is finally declared as a valid singularity point and kept for further use. Otherwise S is marked as an invalid singularity point of CASE 2 needing correction (detailed below).

The consistency index Cᵢ is set to zero. For each point P in the smoothed original direction field (output from step 510), an MRT is constructed on a block having a default size of W with P as the center. The default block size is W. But as stated above by reference to the MRT construction procedure, the construction of the MRT is not confined within the four corners of the block when bad-quality points are present.

AMRS can now be performed on each MRT constructed as follows. As stated earlier a set of multiple adjustment or correction methodologies or strategies are available to correct direction measures comprising the MRT. Which one of or more of these strategies is selected to perform the correction is determined based on whether the point P being corrected is within or comprises a singularity area or a non-singularity area. Four exemplary direction measure correction strategies are next described.

In accordance with a first strategy, P is determined (step 516) to be within a non-singularity area. Assume dₚ is the smoothed low level direction measure assigned to point P, which corresponds to a working pixel direction dₐ for a point in a higher level (e.g., the next highest adjacent level). Trace several pseudo-ridges around the area of dₐ, connect these pseudo ridges and calculate the pseudo-ridge direction dₐ, for the point P. If the direction |dᵣ−dₚ|>Tₐ, set the dₚ=dᵣ. Otherwise, keep the value of dₚ the same. If dₚ is modified, Cᵢ=Cᵢ+1. In other words, when the direction measure is associated with a non-singularity area, the selected adjusting method determines whether to adjust the direction measure by determining consistency between a corresponding direction measure and at least one neighboring direction measure in a lower resolution direction image in the MRT using pseudo-ridge tracing in an area surrounding the corresponding direction measure.

In accordance with a second strategy, if P is within a certain distance of a valid singularity point and the direction of point P is dₚ, a majority vote or averaging is performed on the original lowest level direction field with a small window size around point P, say T₀×T₀. Set T₀=4, for example, which is smaller than the block size W(8) selected for MRT construction. Assume the result of this operation is dₐ. dₚ is calculated as:

dₚ=f(dₚ, dₐ, Tₐ)

where
f(dₚ, dₐ, Tₐ)=dₚ+α(dₐ−dₚ), 0<α<1, if |dₚ−dₐ|>Tₐ
then f(dₚ, dₐ, Tₐ)=dₚ, otherwise dₚ remains unchanged.
   In the above equation, a is a pre-defined constant. Tₐ is a pre-defined threshold. α and Tₐ are determined experimentally to achieve optimal direction. If dₚ is modified, Cᵢ=Cᵢ+1. In other words, when the direction measure is associated with a valid singularity area, the selected adjusting method determines whether to adjust the direction measure by determining consistency between neighboring direction measures in the first plurality of direction measures on the lowest level direction image.

In accordance with a third case, if P is within certain distance of an invalid singularity point of CASE 1, the high-level direction values are used to guide the smoothing of low-level direction values. If a point's direction in a low level is dₚ, and its corresponding high-level point's direction is dₕdₚ is calculated as:

dₚ=f(dₚ, dₕ, Tₕ)

where
f(dₚ, dₕ, Tₕ)=dₚ+b(dₚ−dₕ), 0<b<1, if |dₚ−dₕ|>Tₕ
then f(dₚ, dₕ, Tₕ)=dₚ, otherwise dₚ remains unchanged.
   In the above equation, b is a pre-defined constant. Tₕ is a pre-defined threshold. b and Tₕ are determined experimentally to achieve optimal direction. Again, if dₚ is modified, Cᵢ=Cᵢ+1.

In accordance with a fourth case, if P is within a certain distance of an invalid singularity point of CASE 2, the point direction measure dₚ is calculated from an interpolation of all the points around P with quality above Q, inside a block window with size T₁. If dₚ is modified, Cᵢ=Cᵢ+1. In other words, when the direction measure is associated with an invalid singularity area, the selected adjusting method determines whether to adjust the direction measure by determining consistency between the direction measure and a corresponding direction measure in a lower resolution direction image or consistency between the direction measure and at least one of its neighboring direction measures.

The above-described four strategies can be used separately or combined. For example, if P is not in any of the first, second, third and fourth situations, it can be determined whether its direction dₚ is within certain range of the direction of correspondent points in every level of the MRT. If it is, dₚ is not changed. Otherwise dₚ is calculated using the third strategy and set Cᵢ=Cᵢ+1.

Embodiment 1 deals with every point separately of the highest resolution direction image, and a MRT is constructed for every point. This implementation is accurate but time-consuming. A second embodiment of ARMS based on MRT described below is associated with a decreased computation time. In the second embodiment, a MRT is constructed for the whole image. The validity of cores and deltas are judged in the same way as the first embodiment, but using the MRT for the whole image, wherein direction measures assigned to corresponding high-level points in the MRT are used to guide the judgment. The consistency index Cᵢ is set to zero. Smoothing using the four above-described strategies is performed similarly to the first embodiment and is performed for every level in the MRT, from the highest level to the lowest level. However, in this embodiment the Cᵢ is not going to be changed until smoothing the lowest level, e.g., the original direction field. Every low-level smoothing is guided by the already smoothed high-level points. Thus the order of high to low smoothing is usually followed.

If the consistency index Cᵢ is greater than a threshold T_{c}, (step 530) return to step 512, core and delta detection. T_{c} can be set according to application requirements. For example, T_{c} can be set higher if computation time is limited, else T_{c} can be set to 0. The direction field output from step 528 is be used for the new round of core/delta detection and direction field smoothing. Otherwise, the direction field is considered consistent enough and the final direction field and singularity points are output at step 532 to the next step of fingerprint image processing.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A method for processing a print image comprising the steps of:
generating a first direction image corresponding to the print image and comprising a first plurality of direction measures;
detecting a boundary between print areas and non-print areas in the print image;
determining image quality of the print image;
generating at least one multi-resolution hierarchy tree (MRT) comprising a set of direction images each having a different resolution, the set comprising the first direction image having a highest resolution and at least a second direction image having a lower resolution than the first direction image, the at least a second direction image comprising a second plurality of direction measures that are each determined from selected direction measures, in a higher resolution direction image, which are selected based at least on one of image quality and the selected direction measures corresponding to a point in a print area;
differentiating between any singularity area comprising at least one singularity point and non-singularity areas, in each direction image in the set;
determining whether to adjust at least one direction measure in the first and second pluralities of direction measures to generate a final first direction image, the adjusting being performed using at least one selected adjusting method, from a set of multiple adjusting methods, which is selected based at least on whether the direction measure being adjusted is associated with a singularity area or a non-singularity area; and
outputting the final first direction image and each detected singularity point in the final first direction image.

2. The method of claim 1, further comprising the steps of:
computing a consistency measure based on the final first direction image;
comparing the consistency measure to a predetermined consistency metric, wherein the final first direction image and each detected singularity point is output if the consistency measure satisfies the consistency metric.

3. The method of claim 2 further comprising iteratively performing, using the at least one MRT comprising the final first direction image, the steps of:
differentiating between any singularity area comprising at least one singularity point and non-singularity areas, in each direction image in the set;
determining whether to adjust at least one direction measure in the first and second pluralities of direction measures to generate a final first direction image;
computing the consistency measure based on the final first direction image; and
comparing the consistency measure to the predetermined consistency metric, until the consistency measure satisfies the consistency metric.

4. The method of claim 2, wherein the consistency measure is a function the number of direction measures in at least the first plurality of direction measures that were adjusted.

5. The method of claim 1, wherein the print image comprises one of a fingerprint image, a toe print image and a palm print image.

6. The method of claim 1, wherein the set of multiple adjusting methods comprises at least a first adjusting method, wherein the direction measure is adjusted based at least on a direction measure from a lower resolution direction image in the MRT, and a second adjusting method that includes the step of tracing at least one neighboring pseudo-ridge.

7. The method of claim 6 further comprising the step of determining validity of each detected singularity area before determining whether to adjust at least one direction measure in the first and second pluralities of direction measures to generate the final first direction image.

8. The method of claim 7, wherein validity of each detected singularity area is determined using the at least one multi-resolution hierarchy tree (MRT).

9. The method of claim 8, wherein:
when the direction measure is associated with a non-singularity area, the selected adjusting method determines whether to adjust the direction measure by determining consistency between a corresponding direction measure and at least one neighboring direction measure in a lower resolution direction image in the MRT using pseudo-ridge tracing in an area surrounding the corresponding direction measure;
when the direction measure is associated with a valid singularity area, the selected adjusting method determines whether to adjust the direction measure by determining consistency between neighboring direction measures in the first plurality of direction measures; and
when the direction measure is associated with an invalid singularity area, the selected adjusting method determines whether to adjust the direction measure by determining consistency between the direction measure and a corresponding direction measure in a lower resolution direction image or consistency between the direction measure and at least one of its neighboring direction measures.

10. The method of claim 1, wherein:
a direction measure in a direction image in the set of direction images is determined based only on all the direction measures in a corresponding default set of direction measures in a higher resolution direction image, when each direction measure in the default set exceeds a first predetermined quality threshold; and
a direction measure in a direction image in the set of direction images is determined based on a portion of the direction measures in a corresponding default set of direction measures in a higher resolution direction image that exceed a second predetermined quality threshold and further based on a plurality of direction neighboring a remaining portion of the default set, wherein the neighboring direction measures also exceed the second predetermined quality threshold.

11. Apparatus for processing a print image comprising:
an interface receiving the print image; and
a processing device coupled to the print image and performing the steps of:
generating a first direction image corresponding to the print image and comprising a first plurality of direction measures;
detecting a boundary between print areas and non-print areas in the print image;
determining image quality of the print image;
generating at least one multi-resolution hierarchy tree (MRT) comprising a set of direction images each having a different resolution, the set comprising the first direction image having a highest resolution and at least a second direction image having a lower resolution than the first direction image, the at least a second direction image comprising a second plurality of direction measures that are each determined from selected direction measures, in a higher resolution direction image, which are selected based at least on one of image quality and the selected direction measures corresponding to a point in a print area;
differentiating between any singularity area comprising at least one singularity point and non-singularity areas, in each direction image in the set;
determining whether to adjust at least one direction measure in the first and second pluralities of direction measures to generate a final first direction image, the adjusting being performed using at least one selected adjusting method, from a set of multiple adjusting methods, which is selected based at least on whether the direction measure being adjusted is associated with a singularity area or a non-singularity area; and
outputting the final first direction image and each detected singularity point in the final first direction image.

12. The apparatus of claim 11, wherein the apparatus is included in an Automatic Fingerprint Identification System (AFIS).

13. The apparatus of claim 11, wherein the processing device comprises at least one of: microprocessor executing code, an Application Specific Integrated Circuit (ASIC), a field programmable gate array (FPGA) and a state machine.

14. The apparatus of claim 11, wherein the processing device further iteratively performing, using the at least one MRT comprising the final first direction image, the steps of:
differentiating between any singularity area comprising at least one singularity point and non-singularity areas, in each direction image in the set;
determining whether to adjust at least one direction measure in the first and second pluralities of direction measures to generate a final first direction image;
computing a consistency measure based on the final first direction image; and
comparing the consistency measure to a predetermined consistency metric, until the consistency measure satisfies the consistency metric, wherein the final first direction image and each detected singularity point is output when the consistency measure satisfies the consistency metric.

15. A computer-readable storage element having computer readable code stored thereon for programming a computer to perform a method for processing a print image, the method comprising the steps of:
generating a first direction image corresponding to the print image and comprising a first plurality of direction measures;
detecting a boundary between print areas and non-print areas in the print image;
determining image quality of the print image;
generating at least one multi-resolution hierarchy tree (MRT) comprising a set of direction images each having a different resolution, the set comprising the first direction image having a highest resolution and at least a second direction image having a lower resolution than the first direction image, the at least a second direction image comprising a second plurality of direction measures that are each determined from selected direction measures, in a higher resolution direction image, which are selected based at least on one of image quality and the selected direction measures corresponding to a point in a print area;
differentiating between any singularity area comprising at least one singularity point and non-singularity areas, in each direction image in the set;
determining whether to adjust at least one direction measure in the first and second pluralities of direction measures to generate a final first direction image, the adjusting being performed using at least one selected adjusting method, from a set of multiple adjusting methods, which is selected based at least on whether the direction measure being adjusted is associated with a singularity area or a non-singularity area;
computing a consistency measure based on the final first direction image;
comparing the consistency measure to a predetermined consistency metric; and
outputting the final first direction image and each detected singularity point in the final first direction image when the consistency measure satisfies the consistency metric, wherein when the consistency measure does not satisfy the consistency metric iteratively performing, using the at least one MRT comprising the final first direction image, the steps of differentiating between any singularity area comprising at least one singularity point and non-singularity areas, in each direction image in the set; determining whether to adjust at least one direction measure in the first and second pluralities of direction measures to generate a final first direction image; computing the consistency measure based on the final first direction image; and comparing the consistency measure to the predetermined consistency metric, until the consistency measure satisfies the consistency metric.

16. The computer-readable storage medium of claim 15, wherein the computer readable storage medium comprises at least one of a hard disk, a CD-ROM, an optical storage device and a magnetic storage device.
